(19) United States
(12) Patent Application Publication
(10) Pub. No.: US 2007/0131613 A1
(43) Pub. Date: Jun. 14, 2007

(54) Water treatment

(75) Inventors: Malcolm Bruce Gordon, Ringwood East (AU); Roy Malcolm Olliff, North Balwyn (AU)

Correspondence Address: VOLPE AND KOENIG, P.C., UNITED PLAZA, SUITE 1600, 30 SOUTH 17TH STREET, PHILADELPHIA, PA, 19103, US

(73) Assignee: New Water Pty Ltd., Ringwood, Victoria (AU)

(21) Appl. No.: 10/590,584

(22) PCT Filed: Mar. 30, 2005
(86) PCT No.: PCT/AU05/00443

§ 371 Date: Aug. 24, 2006

(30) Foreign Application Priority Data
Mar. 30, 2004 (AU) 2004901661

(51) Int. Cl. C02F 3/02

(52) U.S. Cl. 210/620

(57) ABSTRACT

A method of treating water which comprises, forming a mixture of a particulate natural organic substrate with a flow control component, exposing the water to contact with oxygen containing gas over a large surface area, and causing the water to trickle through a column of the mixture, wherein the particulate natural organic substrate is adapted to support growth of aerobic bacteria and the flow control component is adapted to create a plurality of sinuous pathways for the water trickling through the column.

### FIELD OF THE INVENTION

This invention relates to water treatment processes and devices. In specific non-limiting aspects it relates to methods of treating grey water and lightly polluted stormwater, cartridges for treating grey water and grey water treatment assemblies.

### BACKGROUND OF THE INVENTION

Human use of water resources has been increasing in response to increasing human population, agriculture and industrialization. However, the amount of fresh water available for use from rivers, lakes and subterranean basins is a comparatively limited amount on a worldwide basis. Clearly the world population cannot go on increasing indefinitely without putting impossible strains on the current sources of fresh water.

In order to alleviate water shortages, authorities are increasingly relying upon using treated recycled water otherwise known as grey water for all sorts of purposes, particularly where a high quality water resource is not required. Such is the case for watering of lawns, gardens or other similar low risk activities around the dwelling or site. Where public authorities are involved in recycling of water, there needs to be a substantial infrastructure for piping grey water from consumers to a recycling plant and then to an area where it can be used profitably. Whilst this might be a suitable approach for large public or commercial operations, approaches for recycling grey water on a domestic basis for use within a household where the grey water has been generated, are not generally practical. This is due to the lack of readily available domestic grey water treatment systems, the space they occupy and the high cost of installing and maintaining such systems.

Thus, there is a need for an approach for water treatment which may be particularly applicable to grey water and which may be useful in a domestic recycling environment.

Suitably, the approach should involve equipment which does not require substantial maintenance, does not have a large footprint, is easy to operate and is relatively inexpensive.

The present invention seeks to provide a method and devices which go some way towards meeting one or more of these objectives.

### DISCLOSURE OF THE INVENTION

The invention provides in one aspect a method of treating water which comprises, forming a mixture of a particulate natural organic substrate with a flow control component,
exposing the water to contact with oxygen-containing gas over a large surface area, and
causing the water to trickle through a column of the mixture,
wherein the particulate natural organic substrate is adapted to support growth of aerobic bacteria and the flow control component is adapted to create a plurality of sinuous pathways for the water trickling through the column. The oxygen-containing gas may comprise air.

The sinuous pathways may comprise the large surface area for oxygen/water contact.

Suitably the biologically-active substrate is also adapted to support growth of anaerobic and facultative bacteria. The biologically-active substrate may be inoculated with live aerobic bacteria prior to use in the column.

The particulate natural organic substrate may comprise peat, moss, sphagnum moss, compost, lichen, straw, hay, mulch, pulp, rice husks, wheat husks or mixtures of any two or more of the foregoing.

The mixture may be a mixture of an inorganic particulate substrate and a particulate natural organic substance.

In a particular aspect of the invention, the particulate natural organic substrate may comprise peat. The inorganic component may comprise any one or more of PVC, polyethylene, polypropylene or any other suitable component presented in a form where it has a high surface area.

The flow control component may comprise a particulate material which is distributed throughout the column. For example, it may comprise particulate or shredded organic or inorganic material. It may comprise shredded plastic. It may comprise PVC, polyethylene, polypropylene or other suitable material having a high surface area per unit volume.

Additionally or alternatively, the flow control component may comprise one or more tiers of impermeable material arranged throughout the column. Additional flow control means may also be used. The additional flow control means may comprise different layers of particulate materials. For example, they may comprise one or more flow control canisters stacked one above the other, above the column. The flow control canisters in combination with the column may be constructed as a cartridge.

The uppermost canister may contain media which allow for high contact between the water and air. For this purpose it may comprise a material having an average contact surface area per cubic metre above 250 m²/m³. It may comprise particulate material, mesh material, structurally moulded materials or mixtures of any of these.

The middle canister may contain media having a higher surface contact area than the media in the uppermost canister. Suitably, its average surface contact area should be at least 1.5 times that of the media in the uppermost canister.

The column below the canisters may contain the mixture of particulate natural organic substrate and flow control component. Typically the ratio of organic substrate to flow control component will be in the volume range of 1:4 to 2:1, more suitable it may be about 2 to 3. The volume/surface area of the mixture is suitably greater than the volume surface area of the middle canister. The flow control component may typically have a surface area per cubic metre volume greater than 250 m²/m³, more preferably greater than 375 m²/m³.

The column, canister or cartridge may include inflow means for allowing an oxygen containing gas such as air to percolate through the column. Suitably, the inflow means may allow the air to percolate upwards through the column, canister or cartridge whilst allowing water to percolate down through the column. The inflow means may comprise a perforated or porous tube extending into the column, canister or cartridge. Alternatively or additionally the inflow means may comprise a porous container for holding the column, canister or cartridge.

In another aspect, the invention provides a cartridge comprising a column as hereinbefore described. It may be housed within a porous container comprising a geotextile and/or similar material serving the containment purpose. Alternatively, it may comprise a non-porous plastic container with open top and bottom. The air inflow means may extend through the container into the column in the form of a perforated tube. It may also comprise the geotextile which is itself porous.

The column may include secondary distribution means for the water being treated in the column. The secondary distribution means may comprise a funnel which directs water to a position intermediate the height of the column. There may be a plurality of such funnels. The one or more funnels may extend from a position at the top of the column into a region substantially at the midpoint of the height of the column.

Alternatively, they may be arranged so as to deliver the water for treatment at a number of equally spaced heights in the column. Thus for example, water may be arranged to percolate directly into the top of the column whilst a proportion of the water may be directed into the top third of the column by one or more funnels and to a bottom third of the column by one or more additional funnels.

As a means of providing additional treatment, as sometimes required for a higher quality final effluent, the process may include a further form of treatment. This treatment would be placed in a location where the effluent must pass through it after the primary process, this unit may be attached, or not, depending upon the final effluent quality required. This final treatment process may be in the form of disinfection produced by introducing a chemical (such as chlorine) into the outflow and allowing a retention time for desired treatment activity to take place. The vessel designed to facilitate this could be placed at a point where the outflow can be collected to a common stream. Suitably this may be before the final storage. The vessel may take the shape of a cylinder or something similar and be placed horizontal, vertical or at an angle between. The storage may allow for contact between the treated waste and an active chemical so as to allow for a suitable amount of mixing after contact. The chemical may be introduced with a form of pumping, siphon, venturi or air injection whichever may be appropriate for a particular installation.

In another aspect the invention provides a grey water treatment assembly comprising,
a collection reservoir for grey water,
a treatment module comprising a column as hereinbefore described,
a delivery system for feeding the grey water from the collection reservoir to flow through the treatment module, and
a storage reservoir arranged to receive treated grey water after it has passed through the treatment module.

The treatment assembly may comprise a plurality of treatment modules. The treatment modules may comprise cartridges each removably retained within a cartridge casing held in a treatment tank. Thus, the treatment tank may include one or more cartridge casings for receiving a varied number of cartridges and an equal number of showerheads or distribution sprays for directing water for treatment to flow through the columns and any funnels provided at the top of the column. The water may come from the shower heads provided above the cartridges, or from the pipe system below and through distribution sprays.

The casings may include a spigot for fitting into a tube formed at the bottom of each cartridge casing to allow oxygen containing gas such as air to permeate upwards through the cartridge.

Preferred aspects of the invention will now be described with reference to the accompanying drawings.

### BRIEF DESCRIPTION OF THE DRAWINGS

FIG. 1 shows an elevational view of a vertical section taken through the centre of a cartridge according to the invention;

FIG. 2 shows a vertical section taken through a funnel for use with the cartridge;

FIG. 3 shows a vertical section taken through a treatment tank for use with the invention;

FIG. 4 shows the section A taken through the dispersion manifold shown in FIG. 3;

FIG. 5 shows the section B taken through FIG. 3;

FIG. 6 shows a concept drawing of the operation of the treatment tank shown in FIG. 3;

FIG. 7 shows a concept drawing of a treatment assembly according to the invention;

FIG. 8 shows an elevational view of a vertical section taken through the centre of an alternative form of cartridge according to the invention;

FIG. 9 shows a plan view taken from the top of the cartridge of FIG. 8;

FIG. 10 shows a plan view taken from the base of the cartridge of FIG. 8; and

FIG. 11 shows a concept drawing of a treatment tank/module using the cartridges shown in FIG. 8.

### DETAILED DESCRIPTION OF THE PREFERRED EMBODIMENTS

The various elements identified by numerals in the drawings are listed in the following integer list.

### INTEGER LIST

1 Cartridge
3 Outer wall
4 Filling
5 Central tube
7 Hole
9 Flange
10 Fuse joint/mechanical joint
11 Distributor funnel
12 Location point
13 Treatment tank
15 Outer casing
16 Dispersion manifold
17 Cartridge casing
20 Inlet tube
22 Holes
24 Shower head
25 Shower holes
26 Seal
27 Spigot member
29 Outlet
30 Open region
31 Air passage
32 Air inlet
33 Motor
34 Air outlet
40 Inlet pipe
42 J tube
43 Valve
46 Collection reservoir
48 Vent
49 Vent/overflow pipe
51 Removable sealing cap
52 Valve
53 Power source (solar)
54 Pump
55 Motor
56 Variable speed drive
57 Timer
58 Flowswitch
61 Coarse strainer
63 Outlet line
65 Storage reservoir
66 Overflow line
67 Valve
68 Reuse line
69 Valve
70 Valve
71 Recycle line
72 Air
74 Valve
76 Extra treatment station
80 Cartridge
82 Column
83 Middle canister
84 Upper canister
85 Container
87 Hollow
89 Neck
90 Step
91 Base
93 Hole
95 Annular pad
97 Organic media
98 Inorganic media
99 Inorganic media
101 Air conduit
102 Outlet holes
103 Water conduit
104 Seal
105 Sprinkler assembly
106 Outer wall
108 Sprinkler head
109 Sludge trap
110 Air inlet line
112 Fan/pump
114 Inlet pipe
116 Outlet line
118 Air outlet
120 Treatment tank/module

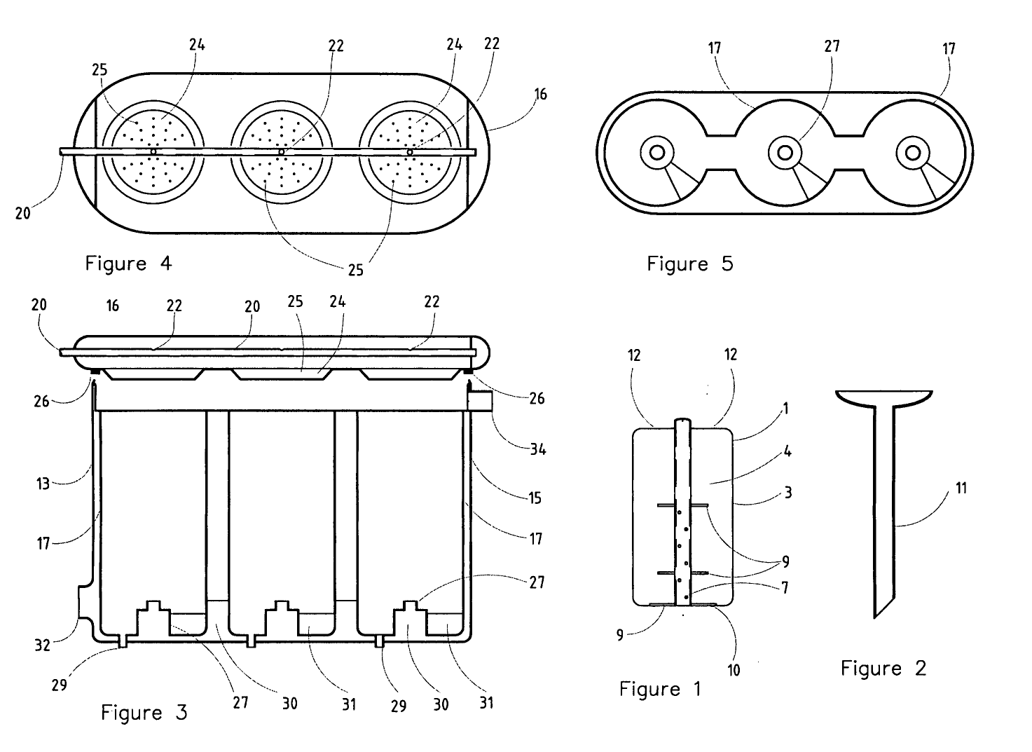

Referring to FIG. 1, the cartridge generally designated 1 shown therein comprises an outer wall 3 of a gas permeable material such as geotextile fabric.

The geotextile fabric holds the filling 4 which comprises the treatment agent in the form of a column held in the cartridge. The filling may typically comprise a natural organic particulate material which acts as a substrate for aerobic bacteria. It has been found that peat can be quite effective as an organic substrate for aerobic and anaerobic bacteria.

Mixed with the particulate peat forming the filling is a material which tends to bulk up the peat and create sinuous pathways through the peat for water tricking through the peat whilst at the same time leaving the filling material sufficiently porous to allow air to percolate upwards through the peat. This ensures for a high contact area between the water and air. Particulate shredded plastics mesh material has been found to be very suitable for this purpose.

In addition to the effect achieved by the shredded mesh, the cartridge is provided with a number of flanges 9 surrounding a central tube 5. These flanges also help to divert water flowing down through the cartridge and air percolating upwards from what might otherwise be relatively straight flow paths. They are formed around the central tube 5. They are designed to allow air to travel up through the tube and to pass through a number of holes 7 formed along the length of the tube into the filling in the cartridge.

One of more distributor funnels 11 shown in FIG. 2 may be pushed through the geotextile material at location points 12 on the top of the geotextile material. The distributor funnel or funnels may be added so as to direct a proportion of water flowing onto the top of the cartridge into an intermediate position in the height of the filling in the cartridge. It has been found that use of funnels in this fashion can improve the efficiency of water treatment by the cartridge depending of course upon the height of the treatment cartridge used.

The geotextile material forming the outer wall 3 of the cartridge may be joined to the lowermost flange 9 surrounding the central tube 5 by a circular fuse joint or mechanical joint 10. This holds the central tube within the outer wall gives a degree of structural rigidity to the cartridge when it has been filled with filling 4.

Referring to FIGS. 3 to 5, there is shown a treatment tank generally designated 13 which is set up so that it can removably receive three separate cartridges, the cartridges being individually replaceable as and when they have reached the limit of their useful effective life.

The treatment tank 13 forms a module for the treatment of grey water. It comprises an outer casing 15 formed of a material such as plastics, particularly rotationally moulded plastic. It has a dispersion manifold 16 which acts as lid to seal off the top of the outer casing.

Three cartridge casings 17 are arranged within the outer casing.

These cartridge casings 17 are each formed with a spigot member 27 adapted to co-operate with the central tube 5 of each cartridge so as to provide an entry point for air to the central tube and to correctly locate the cartridge within the cartridge casing.

The outer casing 15 has an air inlet 32 which may optionally include a motor 33 for operating a fan to drive air through the inlet. The air inlet communicates with the open region 30 formed between the base of the cartridge casing 17 and the bottom of the outer casing 15 to act as ducting for allowing air to travel from the inlet 32 through the spigot 27 and air passage 31.

The dispersion manifold 16 includes a seal 26 for sealing off the top of the outer casing.

An inlet tube 20 for delivering grey water extends through the centre of the dispersion manifold and includes a number of holes 22 for allowing grey water to flow down into the showerheads 24 formed at the bottom of the dispersion manifold. A number of shower holes 25 are arranged to evenly distribute grey water to the top of the cartridges 1 and any funnels held in the cartridge casing 17.

Each of the cartridge casings has an outlet 29 for allowing treated water which has passed through a cartridge to be drawn from the treatment tank. Similarly, an air outlet 34 is provided at the top of the outer casing 15 to allow air which has percolated through the cartridge casing to exhaust from the treatment tank.

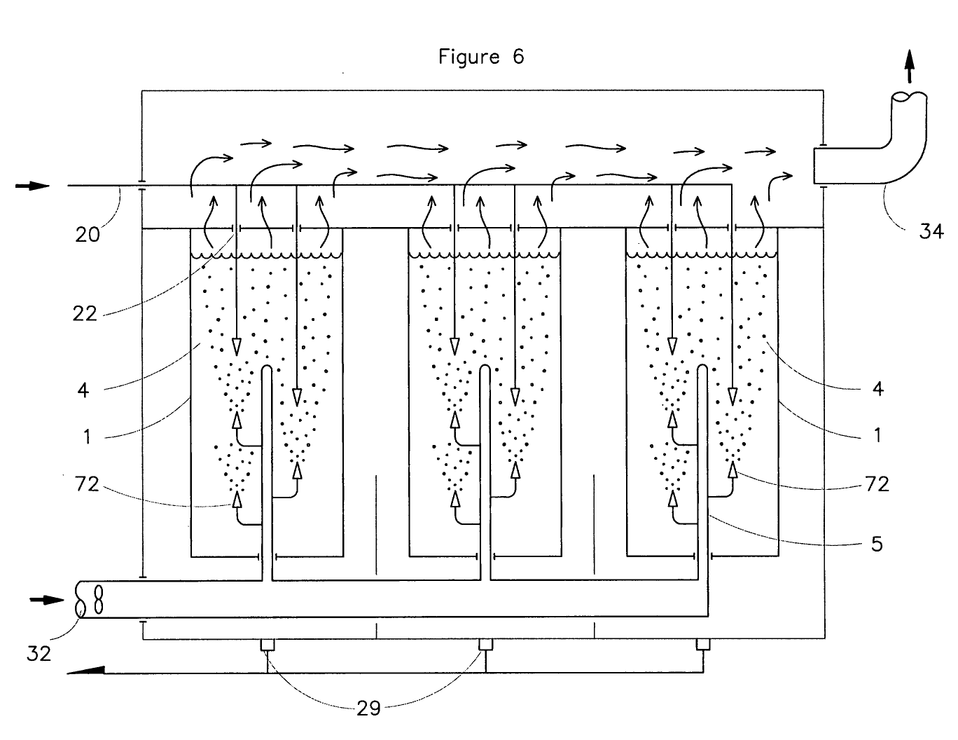

Referring to FIG. 6, it can be seen that the general arrangement of cartridges within the treatment tank allows grey water to enter each of the cartridges via the holes 22 in the showerhead or sprays 24 and to trickle down through the cartridges in a circuitous path. The shredded mesh material forming part of the filling for the cartridge and the flanges 9 contribute to ensuring that the flow of water through the cartridge is circuitous.

Whilst the water is flowing downwardly, air 72 from the central tube 5 and through the porous walls of the cartridge 3 permeates upwardly through the cartridge creating aerobic conditions for bacteria held on and within the peat in the filling. The aerobic bacteria digest unwanted components of the grey water and hence purify and deodorize it.

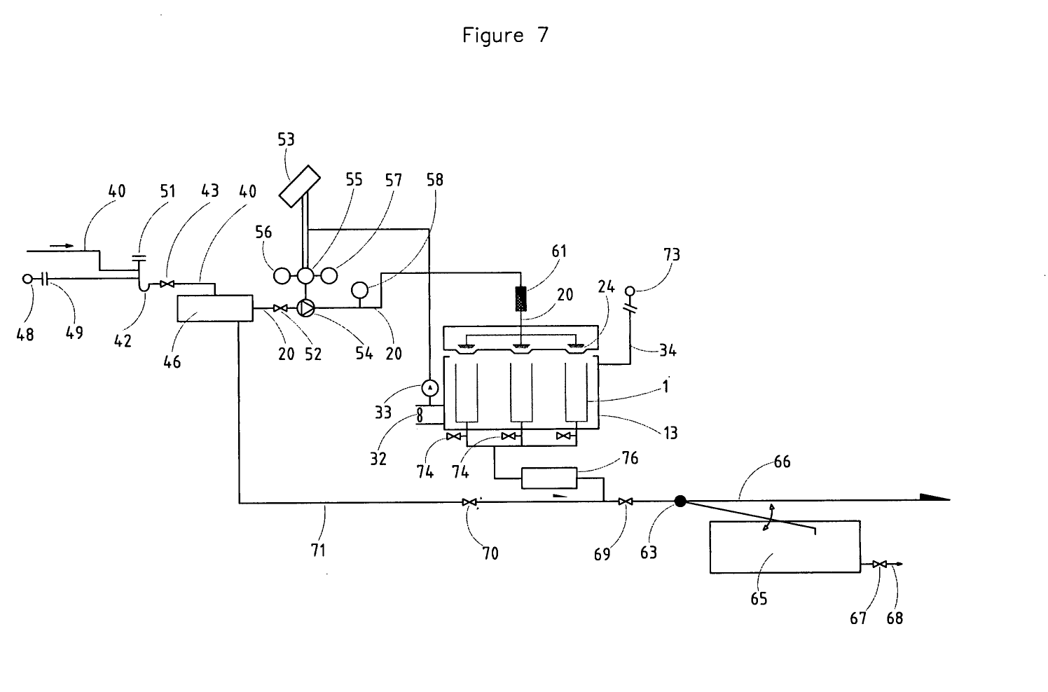

The treatment assembly of FIG. 7 may be used to treat grey water from one or more domestic sources. It includes a treatment tank 13 as described with reference to FIGS. 3 to 6, and an inlet pipe 40 connected via a J-tube 42 and valve 43 to a collection reservoir 46. A vent 48 and vent overflow pipe 49 are connected to the inlet pipe for grey water as is known in the art. A removable sealing cap 51 is also provided on a separate extension of the inlet pipe 40.

The collection reservoir 46 is arranged to direct grey water collected from a household or any other source as and when needed through the inlet tube 20 and valve 52 by means of a pump 54 driven via a motor 55 having a variable speed drive 56. A power source 59 such as a solar collector provides power for the pump and a timer 57 can be used to set appropriate times for when the motor should operate.

As a precaution, a flowswitch 58 may be provided to sense flow through the inlet tube 20 and to shut off the motor when flow from the reservoir 46 stops as a result of the reservoir being empty.

A coarse strainer 61 is provided to strain off coarse materials from the grey water before it enters the treatment tank 13.

A valve 74 is associated with the outlet 29 of each cartridge casing to allow testing of treated water which has passed through the cartridge. The cartridges 1 may be replaced individually as and when testing shows the water quality exiting the cartridge has gone below a predetermined level.

The combined output of water from the cartridges passes through valve 69 to the outlet line 63 and on to a storage reservoir 65 for the treated water.

Optionally an extra treatment station 76 which includes a disinfection process may be included.

An overflow line 66 sends excess water to waste when the storage reservoir has been filled to capacity.

Water can be drawn from the storage reservoir 65 as and when needed through the reuse line 68 after it passes through the valve 67.

The treatment assembly may include the option of recycling water to the collection reservoir 46 should the quality of the water exiting the treatment tank not be at a desired level. Thus the system may include a recycle line 71 through valve 70 to return water to the reservoir 46 ie. when valve 69 is closed and valve 70 is opened, water will return directly to the reservoir 46. Alternatively, when valve 70 is closed and valve 69 is opened, treatment water will go directly to the storage reservoir 65 or the overflow line 66 as the case may be.

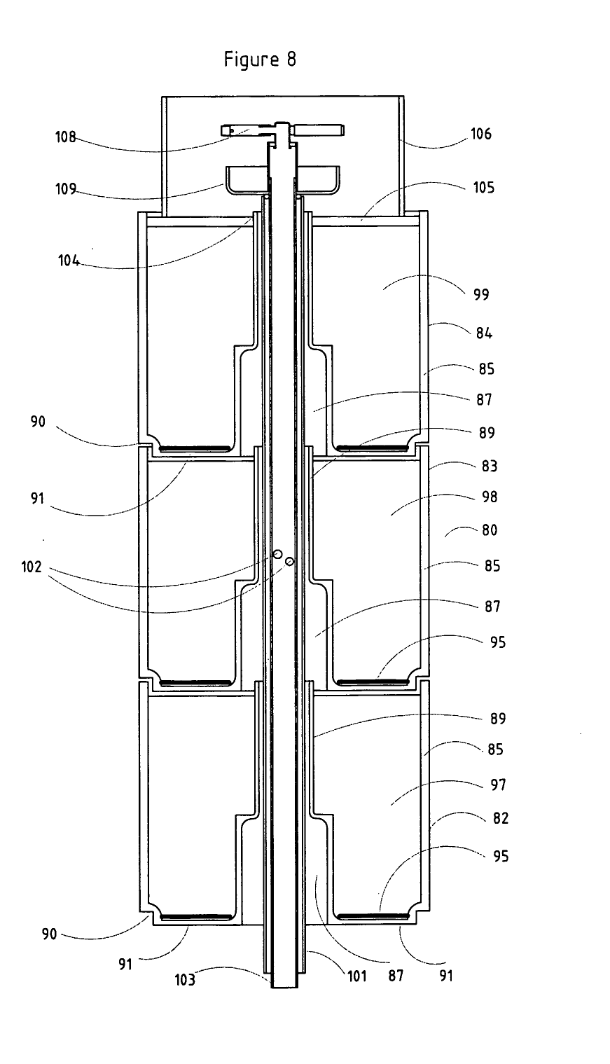

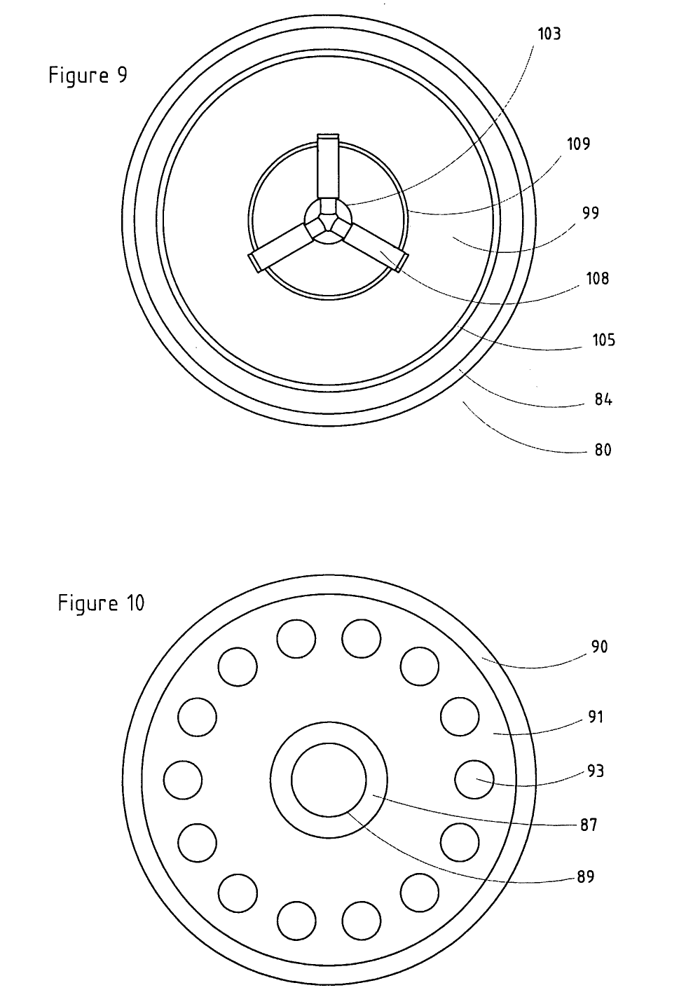

Referring to FIGS. 8, 9 and 10, there is shown a cartridge generally designated 80 which comprises three main components, namely a column 82, a middle canister 83 and an upper canister 84. For ease of construction, the column, middle and upper canister may be formed of similar containers 85 which can be stacked one on top of the other in the manner illustrated. Typically, the containers may be moulded from plastics material.

Each of the containers 85 includes a hollow 87 formed centrally in the base 91 of each container. The hollow extends upwardly and narrows to form an open-ended neck 89.

The base of the containers is also formed with a step 90 to assist with location of the containers when they are stacked one on top of the other. Whilst the two canisters and column for the purposes of this specification are considered to be a cartridge, it is to be appreciated that these three components may be configured together to form a cartridge by stacking them one on top the other without physically binding them together.

The base of each container is provided with a number of holes 93. An annular pad 95 of a porous material such as geotextile fabric or a similar fibrous mesh or filter material is placed on top of the base so as to allow drainage of water through the pad and holes.

The lowermost container 85 comprising the column 82 is filled with organic media 97 mixed with a flow control component. Typically, the organic media may comprise particulate peat. The flow control component may comprise sand, crushed aggregate or any other material which presents a high surface area per unit volume and which creates a plurality of sinuous pathways for water trickling through the column. Examples of flow control materials may include particulates, moulding or mesh. Typically, the volume of the peat to the flow control component falls within the range 1:4 to 2:1. Furthermore, the mixture of peat and flow control component suitably has an average surface area per unit volume of at least 375 m²/m³.

The middle canister contains inorganic media 98 which may typically comprise a material such as gravel having an average surface area per unit volume of at least 375 m²/m³.

The upper canister 84 may contain inorganic media having an average contact surface area per cubic metre volume greater than 250 m²/m³. Suitably, it may be a very open form of media. It has been found that small plastic pieces which have been moulded to provide a large open surface area are suitable for this purpose.

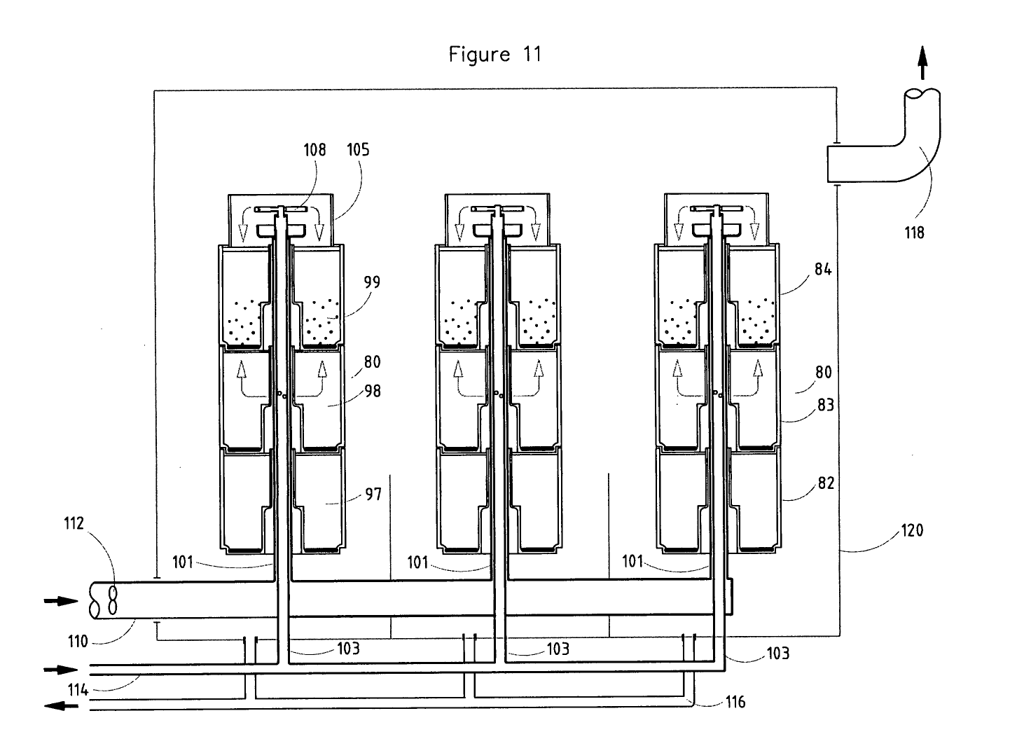

The column and canisters are mounted in a treatment tank/module generally designated 120 in FIG. 11 but shown more clearly in terms of arrangement of conduits in FIG. 8. In this regard, the containers 85 are mounted concentrically with an air conduit 101. The air conduit is provided with outlet holes 102 arranged to allow air fed through the air conduit to flow into the neck 89 of the middle canister and hence to flow upwardly so that the air permeates through the bottom of the upper canister and through the media contained therein. A seal 104 seals off the top of the air conduit by making a seal with the water conduit 103 located concentrically within the air conduit.

The water conduit 103 is arranged so that it directs water to the sprinkler assembly 105 sitting atop the cartridge 80.

The sprinkler assembly includes an outer wall 106 which is spaced from, and extends around the sprinkler 108 mounted on the water conduit.

The outer wall extends to a height greater than the sprinkler head to prevent splashing and is provided with a sludge trap 109 to catch sludge falling out of the sprinkler head thus preventing it from entering the upper canister.

Referring to FIG. 11, the cartridges 80 are located in a moulded treatment tank which includes cartridge casings for snugly receiving the three cartridges and ducting for the various air and water inlets and outlets.

In this regard, the treatment tank includes an air inlet line 110 directing air which has been pumped by the fan/pump 112 to the three air conduits 101. Air exits out of the air outlet 118.

Similarly, water is supplied by an inlet pipe feeding the three water conduits 103. The water which has been treated by trickling through the cartridges to exit through the bottom of the three columns 82 is allowed to flow out of the treatment tank 120 via an outlet line 116 to a reservoir or similar.

Thus, the treatment tank 120 described with reference to FIG. 11 may be substituted for the treatment tank 13 in the circuit which has been described with reference to FIG. 7.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge in Australia.

1. A method of treating water which comprises,
forming a mixture of a particulate natural organic substrate with a flow control component,
exposing the water to contact with oxygen containing gas over a large surface area, and
causing the water to trickle through a column of the mixture, wherein the particulate natural organic substrate is adapted to support growth of aerobic bacteria and the flow control component is adapted to create a plurality of sinuous pathways for the water trickling through the column.

2. A method according to claim 1 wherein the oxygen containing gas is caused to permeate through the column whereby the sinuous pathways comprise the large surface area.

3. A method according to claim 1 wherein the particulate natural organic substrate comprises at least one of peat, moss, sphagnum moss, compost, lichen, straw, hay, mulch, pulp, rice husks, wheat husks and mixtures thereof, and the oxygen containing gas comprises air.

4. A method according to claim 3 wherein the particulate natural organic substrate comprises peat.

5. A method according to claim 1 wherein the flow control component comprises a particulate material having a high surface area per unit volume.

6. A method according to claim 5 wherein the flow control component has a surface area per unit volume of at least 250 m²/m³.

7. A method according to claim 5 wherein the flow control component comprises material in the form of particulates, mouldings or mesh.

8. A method according to claim 1 wherein the water is passed through at least one canister loaded with a material having an average contact surface area per cubic metre volume greater than 250 m²/m³ before it trickles through the column.

9. A column for the treatment of water comprising a mixture of a particulate natural organic substrate with a flow control component, wherein the particulate natural organic substrate is adapted to support growth of aerobic bacteria, the flow control component is adapted to create a plurality of sinuous pathways for the water trickling through the column, and the mixture has an average contact surface area per unit volume of at least 375 m²/m³.

10. A column according to claim 9 wherein the particulate natural organic substrate comprises at least one of peat, moss, sphagnum moss, compost, lichen, straw, hay, mulch, pulp, rice husks, wheat husks and mixtures thereof.

11. A column according to claim 9 wherein the particulate natural organic substrate comprises peat, and the volume ratio of natural organic substrate to flow control component falls within the range 1:4 to 2:1.

12. A cartridge comprising an upper canister loaded with media adapted to provide a high surface area for contact between air and water trickling through the cartridge, the media having an average contact surface area per unit volume of at least 250 m²/m³, and a column as defined in claim 9 arranged to receive water which has trickled down through the upper canister to enter the column across an upper surface of the column.

13. A cartridge according to claim 12 comprising a middle canister interposed between the upper canister and column, whereby the middle canister is adapted to receive water which has trickled down through the upper canister and to allow the water to trickle therethrough and on to the upper surface of the column, and the middle canister is loaded with media having an average surface area per unit volume of at least 375 m²/m³.

14. A cartridge according to claim 13 comprising at least one conduit extending through the column, middle canister and upper canister wherein the conduit is porous and is arranged to facilitate permeation of air from the conduit into the upper canister.

15. A grey water treatment assembly comprising,
a collection reservoir for grey water,
a treatment module comprising a column according to claim 9,
a delivery system for feeding the grey water from the collection reservoir to flow through the treatment module, and
a storage reservoir arranged to receive treated grey water after it has passed through the treatment module.

16. A grey water treatment assembly comprising
a collection reservoir for grey water,
a treatment module comprising a column,
a delivery system for feeding the grey water from the collection reservoir to flow through the treatment module, and
a storage reservoir arranged to receive treated grey water after it has passed through the treatment module,
wherein the treatment module comprises a cartridge according to claim 12.

17. A grey water treatment module comprising,
a casing for housing a plurality of sockets,
a spigot provided in a base of each socket,
air outlet means for each spigot in communication with air inlet means to the module,
liquid outlet means at the base of each socket, and
a column according to claim 9 mounted on each spigot.

18. A grey water treatment module comprising,
a casing for housing a plurality of sockets,
a spigot provided in a base of each socket,
air outlet means for each spigot in communication with air inlet means to the module,
a liquid outlet means at the base of each socket, and
a cartridge according to claim 13 mounted on the spigot.
